(19) United States
(12) Patent Application Publication
(10) Pub. No.: US 2005/0136761 A1
(43) Pub. Date: Jun. 23, 2005

(54) Fire-Retardant Composite Material

(75) Inventors: Shinji Murakami, Settsu-shi (JP); Christopher Snowden Moore, Wilmington, DE (US)

Correspondence Address: SHINJYU GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi (JP)

(21) Appl. No.: 10/904,217

(22) Filed: Oct. 29, 2004

(30) Foreign Application Priority Data
Dec. 17, 2003 (US) 60/529,987

(51) Int. Cl. B32B 27/04

(52) U.S. Cl. 442/59; 428/292.1

(57) ABSTRACT

A fire-retardant composite structure which includes a balsa core layer, fiberglass reinforcing layers attached to either side of the core layer, a PTFE porous layer attached to one of the fiberglass layers or to a fiberglass veil, and a gel coat layer over the PTFE porous layer. Matrix resin bonds the fiberglass layers to the balsa core member, as well as the PTFE porous layer to the fiberglass layers by impregnation.

### BACKGROUND OF THE INVENTION

### FIELD OF THE INVENTION

The present invention generally relates to a fire retardant composite material. More specifically, the present invention relates to a composite structure imparted with a fluoropolymer layer therein in order to retard the spread of fire, and also relates to a process of manufacturing such fire retardant composite structure.

### Background Information

Conventionally, composite materials are used to manufacture panels and parts for transit vehicles and ships to reduce the weight of such transit vehicles and ships. Although composite structures are superior in terms of weight reduction compared with metal structures, they are inferior to metal materials (such as steel sheets) in terms of the ability to retard the spread of a fire. Therefore, in order to safely replace metals with composites, the industry and government have developed a number of fire safety standards for composite structures to assure their fire resistance. For example, in the United States, the rail transportation industry requires manufacturers of composite structures to have their products comply with National Fire Protection Association standard #130, or other standards based upon American Society of Test Methods E162 and E662 tests, in order to delay the spread of a fire and reduce smoke generation at the time of a fire.

Many such composite structures use glass fibers as one of the components. Although glass fiber itself is noncombustible, it does not function as a fire retardant when used in a composite structure. Therefore, composite structures which include glass fiber and matrix resin cannot comply with all the required standards. Furthermore, additional materials are used in composite structures such as foams, engineered honeycomb sheets, porous wood such as end grain balsa, and others can also be used as reinforcement or core materials to reduce cost and weight and to provide insulation and other physical properties. In these cases, the surface layers of the composite structures must be engineered with higher resistance to fire in order to pass fire testing standards.

Conventionally, fire-retardant composite structures have, for instance, a surface coating layer (gel coat) that provides aesthetic and other properties, and can be made to reduce smoke generation during a fire. Conventional fire spread retardant composite structures may also have ignition-delaying materials positioned in between the surface layer and the glass fiber or reinforcement layers/core layers, which are molded into the structure of the composite. Generally, it is known that ignition can be delayed, and the spread of a fire can be retarded, by using a hydrate powder combined with the matrix resin as a fire-retardant layer. This type of fire-retardant layer allows water to be evaporated when the temperature increases, thus slowing the spread of a fire along the surface of the composite.

FIG. 1 shows an example of conventional composite materials used in a composite structure for vehicles.

The composite has a basic sandwich structure having a balsa core member 12 and two glass fiber layers 11A and 11B. The composite includes an intumescent mineral wool based thermal insulation layer 13, similar to Technofire® (a product of Technical Fibre Products Ltd.), a skin coat layer 14 comprising aluminum tri-hydrate (ATH) as a fire retardant blended with matrix resin and glass mat (formed from glass fibers), a gel coat layer 15 which is a surface coating layer, and a matrix resin that is impregnated to bond these layers. Each layer is impregnated with matrix resin, so that, upon curing, the layers are attached to one another to produce the composite structure. The ATH powder in layer 14 is blended into the skin coat matrix resin that is used to bond the glass mat to the surface or gel coat 15. However, since ATH-blended matrix resins are higher in viscosity and tend not to spread uniformly when applied to the layers, it is difficult to obtain a uniform layer of fire protection in composite material made by this process.

It has also been also conceived to use a low porosity sheet, or expanded film of PTFE (polytetrafluoroethylene) as a fire retardant layer, instead of using an ATH-blended matrix resin. In such cases, it has been conceived to attach a sheet of low porosity PTFE to reinforcements or core materials within the composite structure. However, a low porosity PTFE sheet does not adhere to other layers well, and tends to separate in normal usage. Furthermore, the low porosity PTFE can interfere with or prevent the proper infusion and bonding of matrix resin which holds the composite structure together.

In view of the above, it will be apparent to those skilled in the art from this disclosure that a need exists for an improved fire-retardant composite material that overcomes the problems described above. This invention addresses this need in the art as well as other needs, which will become apparent to those skilled in the art from this disclosure.

### SUMMARY OF THE INVENTION

An object of the invention is to provide a composite structure having a porous fluoropolymer layer, which can be readily impregnated with the matrix resin and which possesses the ability to retard the spread of a fire.

The present invention in its first aspect provides a fire-retardant composite structure having a fire retardant layer having a porous fluoropolymer layer, and a matrix resin.

In the composite structure according to the first aspect, the ability to retard the spread of fire is imparted to the composite structure by using a porous fluoropolymer resin layer as a fire retardant layer, so that when the surface of the composite material is burned, the porous fluoropolymer layer slows the spreading of the fire along the exposure surface. Furthermore, the thickness of the composite material can be advantageously reduced in comparison with a conventional fire retardant layer that has ATH and intumescent (char creating) insulation layers, yet still pass ASTM E162 testing.

The present invention in its second aspect provides the fire retardant composite structure of the first aspect, and further includes a structural layer. In addition, the matrix resin is impregnated at least partially into the porous fluoropolymer layer and the structural layer such that the porous fluoropolymer layer and the structural layer are attached to one another.

The present invention in its third aspect provides the fire-retardant composite structure of the first aspect, where the porous fluoropolymer layer includes at least one selected from the group consisting of expanded PTFE, woven fabric, non-woven fabric, felt, fiber, and powder.

The present invention in its fourth aspect provides the fire-retardant composite structure of the first aspect where the porous fluoropolymer layer includes non-melt-processable resin.

The present invention in its fifth aspect provides the fire-retardant composite structure of the first aspect, where the porous fluoropolymer layer includes PTFE. Here, a PTFE resin is used to manufacture the porous fluoropolymer layer material of the composite structure. PTFE exhibits a high LOI (limiting oxygen index) value of 95%. In addition, because PTFE has high melt viscosity, the composite can be imparted with excellent dimensional stability at high temperature, while providing the ability to retard the spread of fire.

The present invention in its sixth aspect provides the fire retardant composite structure of the first aspect, where the fluoropolymer resin layer includes PTFE fibers. Here, the use of PTFE fibers (fiber diameter from 1 μm to 200 μm) in the construction of a porous material advantageously increases the degree of resin impregnation. Due to the greater resin impregnation of such a porous material compared with a porous expanded membrane, the time required for the impregnation process can be reduced. The fiber based fluoropolymer fabric can be bonded strongly to surrounding other layers such as reinforcement layers and gel coat, as the matrix resin can penetrate through the fabric more easily and completely than with an expanded membrane. Thus, the layer of fluoropolymer fibers helps to prevent blistering and de-lamination even better than expanded PTFE membrane or other low porosity fluoropolymer materials.

The present invention in its seventh aspect provides the fire-retardant composite structure of the first aspect, where the porous fluoropolymer layer is a non-woven fabric that includes PTFE fibers.

The present invention in its eighth aspect provides the fire-retardant composite structure of the first aspect, where the porous fluoropolymer layer is a blended combination comprised of PTFE fibers and another material or materials.

The present invention in its ninth aspect provides the fire-retardant composite structure of the first aspect, where the porous fluoropolymer layer includes modified PTFE.

The present invention in its tenth aspect provides the fire-retardant composite structure of the ninth aspect, where the modified PTFE is created by copolymerizing PTFE with at least one selected from the group consisting of hexafluoro propane, chloro trifluoro ethylene, perfluoro(alkyl vinyl ether), perfluoro(alkoxy vinyl ether), trifluoro ethylene, perfluoro alkyl ethylene, vinylidene fluoride, and ethylene.

The present invention in its eleventh aspect provides the fire-retardant composite structure of the first aspect, where the porous fluoropolymer layer has a porosity between approximately 10% and approximately 90% prior to infusion with matrix resin.

The present invention in its twelfth aspect provides the fire-retardant composite structure of the first aspect, where the porosity of the porous fluoropolymer layer is between approximately 25% and approximately 85% prior to infusion with matrix resin.

The present invention in its thirteenth aspect provides the fire-retardant composite structure of the first aspect, where the porous fluoropolymer layer has a mean CP porous diameter of at least 0.5 μm prior to infusion with matrix resin.

The present invention in its fourteenth aspect provides the fire-retardant composite structure of the first aspect, where the porous fluoropolymer layer has a mean CP porous diameter of at least 4.5 μm prior to infusion with matrix resin.

The present invention in its fifteenth aspect provides the fire-retardant composite structure of the first aspect, where the porous fluoropolymer layer includes pores that are sized to allow the matrix resin to flow therein and through to bond the various layers together into one monolithic composite structure.

The present invention in its sixteenth aspect provides the fire-retardant composite structure of the first aspect, where the porous fluoropolymer layer is attached to one or more other layers prior to composite fabrication.

The present invention in its seventeenth aspect provides the fire-retardant composite structure of the first aspect, where the matrix resin is at least one selected from the group consisting of vinyl ester resin, vinyl ester bromide resin, epoxy resin, unsaturated polyester resin, epoxy acrylate resin, polyimide resin, phenolic, and bismaleimide resin.

The present invention in its eighteenth aspect provides the fire retardant composite structure of the second aspect, where the structural layer includes at least one selected from the group consisting of glass fiber, carbon fiber, alumina fiber, silicon carbide fiber, boron fiber, p-Aramid fiber, polybenzimidazol fiber, polyetheretherketone (PEEK), graphite, and poly-p-phenylbenz-bisthiazol fiber.

The present invention in its nineteenth aspect provides the fire-retardant composite structure of the second aspect, where the structural layer includes first and second reinforcement layers and a core layer. The core layer is provided between the first and second reinforcement layers, wherein multiple layers of porous fluoropolymer are used to further increase the fire protection of the composite structure. Furthermore, a layer or layers of the porous fluoropolymer can be used to provide fire-protection to any or all of the exterior or interior surfaces of the composite structure.

The present invention in its twentieth aspect provides the fire-retardant composite structure of the second aspect, where the fire retardant layer further includes an intumescent layer.

The present invention in its twenty first aspect provides the fire-retardant composite structure of the twentieth aspect, where the intumescent layer is placed between the porous fluoropolymer layer and the structural layer, yet as close to the outside surface of the composite structure as possible to provide fire protection.

The present invention in its twenty second aspect provides the fire-retardant composite structure of the twentieth aspect, where the fire retardant layer further includes a restraining layer. The restraining layer does not interfere with the char formation and expansion of the intumescent layer, but does restrain it from falling off the composite thus rendering the charred intumescent layer more effective and durable.

The present invention in its twenty third aspect provides the fire-retardant composite structure of the twenty second aspect, where the restraining layer is interposed between the intumescent layer and the porous fluoropolymer layer in order to hold the intumescent layer to the structural layer during exposure to flame and thus increase its effectiveness.

The present invention in its twenty fourth aspect provides the fire-retardant composite structure of the twenty second aspect, where the porous fluoropolymer layer is combined with the restraining layer prior to composite fabrication. The restraining layer should be designed to allow for expansion of the char layer of the intumescing layer, yet still hold the fire protection fluoropolymer layer together as expansion occurs and as the exposed composite experiences shocks and vibration. This is typically achieved using a high temperature fiber laid out in a continuous filament veil or nonwoven. Woven structures typically don't have enough expansion capability and therefore prevent or reduce the beneficial expansion of the char insulating layer of the intumescing layer.

Here, wrinkling and deformation of PTFE fibers that tends to occur when filling the mold prior to resin impregnation, or during the manual hand lay up processing can be prevented by combining the PTFE fibers and the restraining layer in advance. This way, the amount of resin used between the restraining layer and the fluoropolymer resin layer can also be reduced, since the combination of the restraining layer and porous fluoropolymer layers gives a stronger material prior to infusion which can have excess matrix resin removed more successfully. This physical combination or attachment of the restraining layer and the fluoropolymer layer can reduce construction time and manufacturing bottlenecks by unifying multiple processing steps. Furthermore, de-lamination of the fluoropolymer layer due to the expansion of the matrix resin at high temperature and the difference in thermal expansion between the two fiber layers can be prevented.

The present invention in its twenty fifth aspect provides the fire-retardant composite material of the twenty second aspect, where the porous fluoropolymer layer is combined with the restraining layer by entanglement prior to composite fabrication.

The present invention in its twenty sixth aspect provides the fire-retardant composite material of the twenty fifth aspect, where the entanglement is performed by mechanical means such as needle punching, or hydro-entangling.

The present invention in its twenty seventh aspect provides the fire-retardant composite material of the twenty second aspect, where the restraining layer includes glass fibers or a blend of glass fibers with fluoropolymer fibers.

The present invention in its twenty eighth aspect provides the fire-retardant composite structure of the second aspect, where at least one of the porous fluoropolymer layer and the structural layer has one of a hydroxide, salt, and oxide of an alkali-earth metal mixed therein. Here, an alkali earth is mixed within the porous fluoropolymer layer or in close proximity thereto. This way, hazardous fluorinated gases and compounds that are generated during pyrolysis of the PTFE layer can be neutralized. For instance, premixing calcium with the porous fluoropolymer layer induces a reaction to neutralize hydrofluoric acid, thereby yielding calcium fluoride and preventing generation of hydrogen fluoride (which is a toxic gas) at the time of fire.

The present invention in its twenty ninth aspect provides the fire-retardant composite structure of its first aspect, further including a surface coating layer applied over the fire retardant layer.

The present invention in its thirtieth aspect provides a fire retardant material which includes a porous fluoropolymer layer, and a glass veil.

The present invention in its thirty first aspect provides the fire-retardant material of its thirtieth aspect, where the porous fluoropolymer layer and the glass veil are combined together by entanglement.

The present invention in its thirty second aspect provides the fire-retardant material of its thirty first aspect, where the entanglement is performed by needle punching.

The present invention in its thirty third aspect provides the fire-retardant material of its thirty second aspect, where the porous fluoropolymer layer and the glass veil are compressed after the needle punching.

The present invention in its thirty fourth aspect provides a vehicle composed at least in part of a fire-retardant composite structure, with the fire-retardant composite structure including a fire retardant layer having a porous fluoropolymer layer, a structural layer, and a matrix resin impregnated at least partially into the porous fluoropolymer layer and the structural layer such that the porous fluoropolymer layer and the structural layer are attached to one another.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic diagram of a conventional composite structure having a fire-retardant layer;

FIG. 2 is a schematic diagram of a composite structure in accordance with a first embodiment of the present invention;

FIG. 3 is a schematic diagram of a composite structure in accordance with a second embodiment of the present invention;

FIG. 4 is a schematic diagram showing one of the methods of manufacturing a composite structure in accordance with the second embodiment of the present invention;

FIG. 5 is an oblique view of a device used in the production of PTFE non-woven fabric;

FIG. 6 is an enlarged view of the nip rollers and scratching roll of the device shown in FIG. 5; and

FIGS. 7 and 8 are graphs showing the length and diameter distribution of PTFE fibers obtained by means of the device shown in FIGS. 5 and 6.

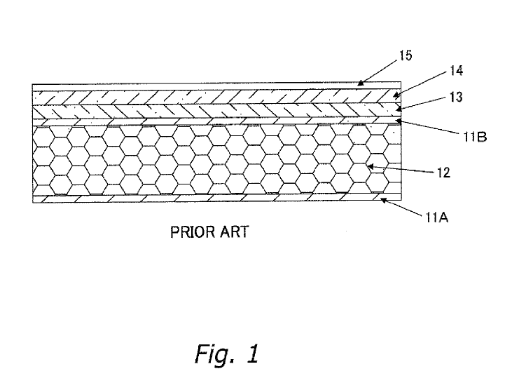

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Fire-Retardant Composite Material

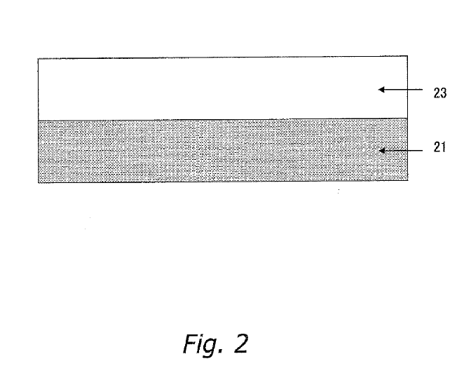

Referring initially to FIG. 2, a composite material is illustrated in accordance with a first embodiment of the present invention. The composite material has a basic structure which includes a porous fluoropolymer fiber layer 23 and a glass fiber layer 21. These layers 23 and 21 are impregnated with a matrix resin, such that these layers 23 and 21 are attached to one another.

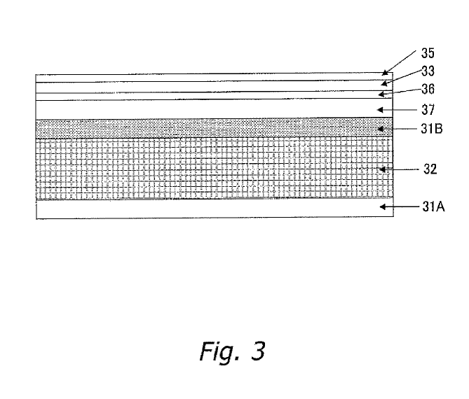

Referring next to FIG. 3, a composite structure is illustrated in accordance with a second embodiment of the present invention.

The composite structure includes structural layers, a fire retardant layer, a surface coating layer, and a matrix resin. The structural layers includes a balsa core layer 32, and first and second glass fiber layers (reinforcement layers) 31A and 31B. The fire retardant layer is provided over the second glass fiber layer 31B and includes a porous fluoropolymer fiber layer 33, a glass veil layer 36 (an example of the restraining layer), and an intumescent layer 37. The intumescent layer 37 is disposed adjacent to the second glass fiber layer 31B. In a preferred configuration, the glass veil layer 36 is interposed between the porous fluoropolymer fiber layer 33 and the intumescent layer 37, however the glass veil layer 36 may instead be arranged on the outer side of the porous fluoropolymer fiber layer 33, i.e., between the surface coating layer and the porous fluoropolymer fiber layer 33. The surface coating layer is a gel coat layer 35, which is provided over the porous fluoropolymer fiber layer 33.

The matrix resin bonds the layers 31-37 to produce the composite structure. The matrix resin is either laid up by hand, or infused in the layers 31-37 to bond the layers 31-37 to one another by impregnation.

In this embodiment, the porous fluoropolymer fiber layer 33 includes one or several calcium compounds mixed therein. These calcium compounds serve to neutralize hazardous fluoride generated during the pyrolysis of the porous fluoropolymer fiber layer 33, and to yield calcium fluoride.

Although glass fiber layers are used as the reinforcement layers 31A and 31B in this embodiment, these reinforcement layers 31A and 31B may be composed of any one of woven glass fiber, carbon fiber, alumina fiber, silicon carbide fiber, boron fiber, p-Aramid fiber, polybenzimidazol (PBI) fiber, polyetheretherketone (PEEK), graphite, and poly-p-phenylbenz-bisthiazol (PBO) fiber. Similarly, although non-woven glass fiber is used as the restraining layer 36 in this embodiment, the layer 36 may also be composed of any one of the materials listed above.

The matrix resin may be any resin selected from the group consisting of vinyl ester resin, vinyl ester bromide resin, epoxy resin, unsaturated polyester resin, epoxy acrylate resin, polyimide resin, phenolic, and bismaleimide (BMI) resin.

Alternatively, instead of using separate layers, the porous fluoropolymer layer 33 and the glass fiber layer 36 may be combined into one layer in advance prior to the assembly of the composite material. For example, such combinations can be accomplished by using physical blending of the fibers and densifying the two layers together, or entanglement by using needle punching or water jet processing. In this case, in addition to improved workability, the use of pre-combined layers reduces a gap between the glass veil layer 36 and the porous fluoropolymer layer 33. In this manner, the ability to retard the spread of a fire at the interface between the glass veil layer 36 and the porous fluoropolymer layer 33 is further improved.

Porous Fluoropolymer Layer

The porous fluoropolymer layer 33 is attached to the second glass fiber layer 31B, over the glass veil layer 36 and the intumescent layer 37, by attaching a porous fluoropolymer layer composed of any material selected from non-melt-processable resins such as PTFE and modified PTFE, and melt-processable resins such as ETFE (ethylene-tetrafluoroethylene copolymer) and PCTFE (polychlorotrifluoroethylene), among others. The porous fluoropolymer layer 33 is most preferably made of PTFE in this embodiment. PTFE is the most preferable because of its high melt viscosity. Due to its high melt viscosity, a PTFE layer is not likely to drip when it is molten. Accordingly, it is possible to prevent the spread of a fire that is caused by dripping melt-processable resin.

In this embodiment, the porous fluoropolymer layer 33 is composed of non-woven fibers with a fiber diameter of 1 μm to 200 μm. Alternatively, the porous fluoropolymer layer 33 can be in the form of expanded PTFE, woven fabric, felt, fiber, or powder. Woven fabrics are generally made by weaving or knitting yarns or filaments. Non-woven fabrics are generally made by blending of the fibers then mechanically or chemically binding the fibers together, or by melt processing. Since it is apparent to one ordinarily skilled in the art how to manufacture porous materials from expanded PTFE, woven fabrics, non-woven fabrics, felts, fibers or powders, further explanation and illustration will be omitted herein.

Non-melt-processable resins, PTFE and modified PTFE

The porous fluoropolymer layer can be manufactured from a non-melt-processable resin. Such non-melt-processable resins include, for example, PTFE and modified PTFE. PTFE generally has a viscosity of 10¹¹ poise. Modified PTFE is created by copolymerizing PTFE with modification agents such as hexafluoro propane, chloro trifluoro ethylene, perfluoro(alkyl vinyl ether), perfluoro(alcoxy vinyl ether), trifluoro ethylene, perfluoro alkyl ethylene, vinylidene fluoride, and ethylene. Modified PTFE generally has a viscosity of 10¹⁰ poise. A porous layer of non-melt-processable resin is created from an original polymer or co-polymer (hereafter both forms shall be referred to as a resin) in the following manner.

The original resin is formed into filament fibers, and staple fibers, using well known commercial processes, and then converted into a woven or non-woven fluoropolymer layer. These commercial processes are broken into three distinct methods.

The first method is a combination of a non melt processable fluoropolymer like PTFE with another polymer which can be melt or solvent processed into a fiber which when combined forms a filament. The melt processable polymer is then burnt out or dissolved leaving the non melt processable fluoropolymer sintered into a fiber. The result of the first method is a off white or brown monofilament fiber which can be converted into a fluoropolymer layer.

The second method is to slit a non melt processable fluoropolymer film into fibers and then expand or draw these thin flat tapes into thin flat fibers which can then be handled like conventional fibers. The result of the second method is a monofilament or very fine tape which can then be handled like conventional fiber and converted into a fluoropolymer layer.

The third commercial method involves the feeding of non melt processable fluoropolymer film or tape into a rotating mechanical ripping or scratching machine (hereafter referred to as the scratching process), which tears the feed stock in fine fibers that have smaller attached side branches extending out randomly from the staple fiber. The result of the third method is a fine staple fiber with many even finer side branches extending out from the main fiber which are then converted into a fluoropolymer layer.

The original resin is formed into an unsintered film by paste extrusion, which is then bi-axially or uni-axially drawn and formed into a porous film (if the resin is PTFE, the porous PTFE film produced in this manner is called expanded PTFE). This film can be improved for the use in fire retardant composites by puncturing or perforating the film to allow improved flow of matrix resin through the film to improve bonding between layers in the composite structure.

The original resin is formed into a film. The non melt processable film is then split apart using a water jet needling process into fibers or thin tapes which can then be formed into a fluoropolymer layer.

Melt-Processable Resin

Examples of melt-processable resin include tetrafluoroethylene-perfluoro (alkyl vinyl ether) copolymer (PFA), tetrafluoro ethylene-hexafluoro propane copolymer (FEP), polychloro trifluoro ethylene (PCTFE), tetrafluoro ethylene-ethylene copolymer (ETFE), tetrafluoro ethylene-hexafluoro propane-ethylene copolymer (EFEP), tetrafluoro ethylene-vinylidene fluoride copolymer (PVdF). A porous layer of melt-processable resin is created from an original material in the following manner.

The original resin is formed into fibers by melt-extrusion, which are then further processed into a porous fluoropolymer layer, or are directly formed into a porous fluoropolymer layer from the molten resin by a spun bond or melt blowing process;

The original resin in the form of an extruded film is formed into a porous fluoropolymer layer by slitting/drawing; and

The original resin in the form of an extruded film is perforated or punched to allow matrix resin to penetrate the extruded film and thereby allow the layers of a composite structure to be bonded together as one structure.

PTFE Fiber

Preferably, the porous fluoropolymer layer 33 is composed of PTFE fiber. PTFE fiber is preferable because of its high limiting oxygen index (LOI), and also its high viscosity at and above its melting point. FIG. 3 shows an example of a fire-retardant composite structure using a non-woven fabric composed of PTFE fiber.

Generally, when the matrix resin content in the fire retardant layer increases, the ability to retard the spread of a fire is compromised. This is also the case with PTFE-based materials. Therefore, it is desirable to increase the apparent density of the PTFE-based fluoropolymer layer prior to the infusion of matrix resin. Preferably, the fluoropolymer layer should have an apparent density of 0.2 to 1.5 g/cm³. For example, a non-woven fabric made with the PTFE fibers formed by scratching has an apparent density of 0.5 to 1.2 g/cm³, which is more preferable. Also, this fluoropolymer layer should have a mean CP porous diameter of at least 0.5 μm. When a sheet of fibers is formed with a mean CP porous diameter of about 13 μm (measurement was conducted using an optical fiber diameter analyzer ODDA 100, a measurement system of Japan Wool Products Inspection Institute Foundation) the porous sheet had excellent drape-ability, which makes the porous sheet particularly suitable for bonding and conforming to three-dimensional curved surfaces like those encountered in composite parts fabrication. Furthermore, when the porous sheet density was increased to 1 g/cm³ using a calendar roll, it was found to have a mean CP porous diameter of 4.5 μm (measurement was performed with a Coulter porometer manufactured by Beckman). Fluoropolymer layers with similar CP porous diameters as the example above were found to have excellent workability and impregnation with matrix resins as compared to the PTFE expanded membrane films with porous diameters of 0.5 to 1 μm which demonstrated poor performance.

The porous fluoropolymer layer 33 and/or the restraining layer 36 may have compounds containing hydroxides, salts, and oxides of alkali-earth metals mixed therein, such that the alkali earth metals are located in the porous fluoropolymer layer or in close proximity thereto. This way, toxic fluoride gases that are generated at the time of pyrolysis from the decomposition of the PTFE in the fluoropolymer layer can be neutralized. For instance, calcium may be pre-mixed with the porous fluoropolymer layer in order to be available to react and neutralize hydrofluoric acid, thereby yielding calcium fluoride and preventing the generation of hydrogen fluoride, which is a toxic gas, at the time of fire.

In the example discussed above, the fire-retardant composite structure uses a non-woven fabric of PTFE as the porous fluoropolymer layer. The non-woven fabric is formed by subjecting an unsintered PTFE tape to a non or partial or full sintering treatment, then drawing this treated tape uniaxially, and then scratching this treated uniaxially drawn tape into fibers, which are then air laid into a non woven fabric. The non-woven fabric made by this process has excellent matrix resin impregnability and drape-ability. Therefore, it can be used as a fire-retardant layer in a composite structure that is to be molded into a three-dimensional structure

Molding

To mold the composite material shown in FIG. 3, the following methods may be used. In the methods described below, a porous sheet of PTFE fiber is used to create the porous fluoropolymer layer.

(1) Open Mold Method (Hand or Spray Lay Up)

Gel coat is applied to a surface of a mold, such that a gel coat layer 35 is formed on the surface. Then, a sheet of PTFE fiber (layer 33) is placed down on top of the hardened gel coat layer 35. After matrix resin is applied to the PTFE fiber layer 33 such that it is bonded to the gel coat and is wet out completely with matrix resin and allowed to cure and harden, then a sheet of glass veil 36 and is placed on top of the PTFE fiber layer 33 with sufficient matrix resin to wet it out completely, and then is allowed to cure and harden. Note that the PTFE fiber layer 33 and the glass veil restraining layer 36 can be applied separately or together as one step after being combined into one fabric. Once the fiberglass restraining layer has hardened and cured sufficiently to allow the next layer to be applied, then the intumescent layer 37 can be placed on top of the last layer and infused with matrix resin and allowed to harden and cure. Following this step, a glass fiber fabric 31B is placed onto the intumescent layer 37 and then infused with matrix resin which is then allowed to harden and cure. Additional layers of glass fabric can be used to create stronger composite structures in the glass fabric layer, for example two layers of fiberglass fabric can used for the glass fiber fabric layer 31B in the composite structure shown in FIG. 3. Then, a balsa layer 32 is laid down on top of the hardened glass fiber fabric layer 31B and once again matrix resin is used such that both sides of the material being laid down are infused and allowed to harden and cure bonding themselves together as one monolithic composite structure. Finally, the final layer of glass fabric 31A is placed onto the balsa layer 32 and infused with resin, which is allowed to cure and harden sufficient to remove the composite structure from the mold. In this example the matrix resin was applied by hand and excess matrix resin was removed with grooved metal rollers. A spray up system using a chopper gun could have been used to apply the catalyzed resin and chopped fiber for some layers but was not preferred due to reduced uniformity of the reinforcement layer. However, the actual method of applying the matrix resin will vary according to the size and complexity of the mold and the engineering requirements of the composite part. It will be apparent to one ordinarily skilled in the art what type of application processes would be recommended and which matrix resins would be used in any given circumstance.

(2) Vacuum Infusion Method (Closed Molding)

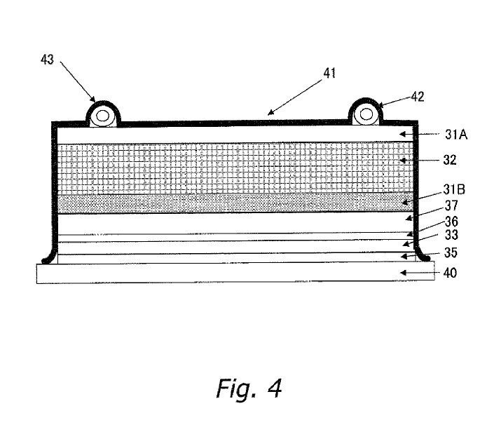

Alternatively, the fire-retardant composite structure of the present invention can be constructed using a vacuum infusion molding method shown in FIG. 4. In this method, impregnation of the matrix resin is accomplished herein by allowing the matrix resin to be pulled into the mold using vacuum, which assists in removing air and improves matrix resin flow. The fire-retardant composite molding diagram of FIG. 4 demonstrates the layout of the composite structure using a construction method wherein all layers are stacked together dry, without matrix resin on top of a hardened gel coat layer, then vacuum sealed in a mold, and later infused with matrix resin. At first, a gel coat is applied to the surface of a mold 40, such that a gel coat layer 35 is formed on its surface. Then, a sheet of PTFE fiber is placed onto the hardened gel coat layer 35 to form a porous PTFE fiber layer 33. The next layer is a fiberglass restraining layer 36 which is laid down on top of the PTFE porous fiber layer 33. The PTFE porous fiber layer 33 and the fiberglass restraining layer 36 are preferentially laid down together in one combined sheet to reduce thickness and to reduce the number of manufacturing steps while still putting the PTFE rich surface against the gel coat 35 and with the fiberglass restraining side facing the intumescing layer 37. The intumescent layer 37 is then laid down on top of the fiberglass restraining layer 36. Then the glass fabric layer 31B may be stacked onto the intumescent layer 37 in one or more layers to meet the structural requirements of the application. Carbon fibers fabrics and other reinforcing materials can be used in layer 31A and 31B in conjunction with fiberglass, or separately as required by the end use of the composite structure. Then, a balsa layer 32 and another layer of glass fabric 31A are placed onto the glass fabric layer 31B in this order to complete the dry stacking process. Thereafter, a vacuum cover 41, which is made of non-air-permeable material to assure tight sealing, is wrapped around the stacked layers and sealed to the mold surface 40. Perforated plastic film called peel-ply and resin distribution mesh are typically laid on top of the glass fiber layer 31A, and under the cover 41 to ease removal of infused, hardened parts and to improve matrix resin infusion respectively. A vacuum system (not shown) removes the air inside the mold through vacuum lines 42 provided in between the cover 41 and the peel ply and glass fiber layer 31A to keep the inner pressure lower than the atmospheric pressure. One the vacuum inside the mold is correct, the catalyzed matrix resin is sucked into the mold through resin distribution tubing 43. The vacuum system and distribution system for each composite mold and structure must be designed to ensure low air void content in the finished composite structures and to ensure complete resin infusion of all layers down to the gel coat so that all the layers are bound together as on monolithic structure.

(3) Hybrid Method (Open Mold Skin Coat Followed by Closed Mold Infusion)

Alternatively, the fire-retardant composite structure of the present invention can be constructed using a hybrid method which combines the open mold or hand lay up method with the vacuum infusion method described above which conforms to FIG. 4. Gel coat is applied to a surface of a mold, such that a gel coat layer 35 is formed on the surface of the mold 40. After the gel coat layer 35 has hardened a thin coating of catalyzed matrix resin is laid out on top of the gel coat. Before the catalyzed matrix resin hardens to where it can not be easily worked by hand, the PTFE porous fabric 33, in combination with the fiberglass restraining fabric 36, or by itself is laid down on top of the matrix resin. Additional catalyzed matrix resin is applied as necessary to the top of the porous PTFE fabric in such a way that the PTFE porous fabric and the restraining fiberglass fabric become completely infused with matrix resin and form a skin coat layer on top of the gel coat 35. There are numerous advantages to using a skin coat layer, such as reducing print thru of reinforcement materials which appear on the composite surface, increasing surface hardness, support of the gel coat to prevent cracking or damage during the dry stacking of additional layers and the ability to use matrix resins which are different than those which are later on used in the infusion portion of the fabrication. The matrix resin is allowed to harden and partially cure, yielding an unfinished composite of gel coat 35, porous PTFE layer 33, and fiberglass restraining layer 36. The additional layers are then laid down on top of the hardened restraining layer 36 dry, without matrix resin in the following order: intumescent layer 37, fiberglass fabric layer 31B, balsa core layer 32, followed by the final fiberglass fabric layer 31A. After all the layers are stacked together, the vacuum cover 41 is sealed to the mold, and distribution system is complete, then the normal process of closed mold infusion of additional matrix resin bonds all of the layers together into one monolithic composite structure.

Although there is only one resin distribution line 43 and two vacuum lines 42, for infusion of the matrix resin in FIG. 4, there may be a plurality of lines. It is apparent to one ordinarily skilled in the art that the number and construction of the lines for vacuum and matrix resin infusion will vary as required by the manufacturing process and sophistication of the composite part.

(4) Other Molding Methods

The composite material shown in FIG. 3 may be molded by other methods, including but not limited to the pressure bag method, autoclave method, cold press method, squeeze method, reservoir method, marco method, resin injection method, vacuum injection method, prepreg method, matched die method, sheet molding compound method, bulk molding compound method, filament winding method, fiber reinforced plastic mortar pipe method, pultrusion method, continuous laminating method, centrifugal method, and rotation method. Note also that the composite material shown in FIG. 3 may also be molded by a combination of two or more of the aforementioned methods.

PTFE Non-Woven Fabric Production Example

PTFE fine powder (manufactured by Daikin Industries, product name F104, melting point 345° C.) was paste extruded and calendared to obtain a non-sintered PTFE film having a thickness of approximately 0.1 3 mm. This non-sintered film was immersed and heat treated in a salt bath at a temperature of 337° C. to obtain a semi-sintered PTFE film having a thickness of approximately 0.1 3 mm. This heat treated film has a crystal conversion ratio (disclosed in International Patent Application Publication No. WO96/00807) of 0.35.

This film was then uniaxially drawn 25× over a hot plate style uniaxial drawing device to obtain a uniaxially drawn, semi-sintered tape having a thickness of 0.03 mm.

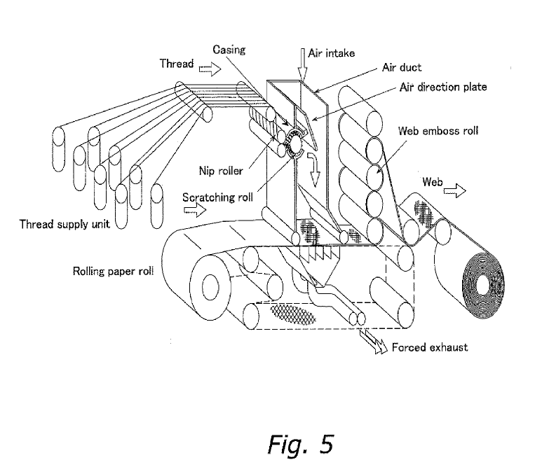

This uniaxially drawn, semi-sintered tape was defibrillated by using a rotating roll covered in fine needles which scratched the fine fibers from the oriented, uniaxially drawn, semi-sintered tape using a process similar to an imitation wool manufacturing device. This process and device has been disclosed in Japanese Published Patent Application No. 2003-278071 (see FIG. 5). The scratched or opened fiber is then deposited onto a fabric carrier in order to obtain a PTFE nonwoven web having a unit weight of 1 00 g/m². More specifically, the defibrillated short fibers obtained by this process were carried away from the scratching device by air flow, which uniformly deposits them onto a PET melt blown non-woven carrier fabric (unit weight 25 g/m2) which has high air permeability, and serves as a collector. The carrier fabric and the collected PTFE fibers then pass out of the scratching machine into an embossing roll or calendar to compress or densify the body of fibers, giving the PTFE nonwoven strength to be handled and processed further without the need of the carrier fabric. The unit weight of the PTFE nonwoven fabric can easily be adjusted by the rate of PTFE fiber deposition and carrier fabric travel through the scratching machine.

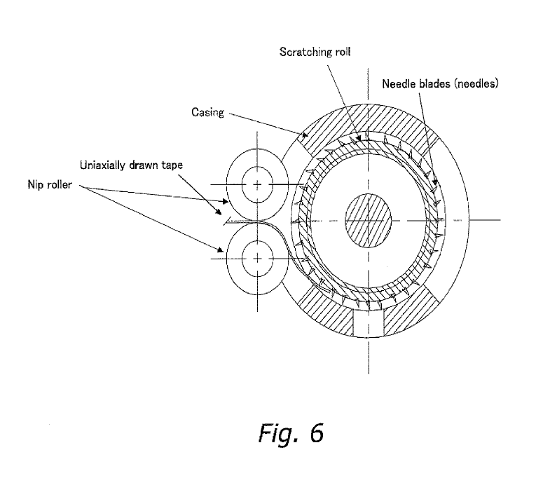

In this example the scratching needle roll was rotated at a surface speed of 2500 m/min, and the rate at which the uniaxially drawn tape was supplied into the scratching roll by the nip roller was 1.5 m/min. (FIG. 6)

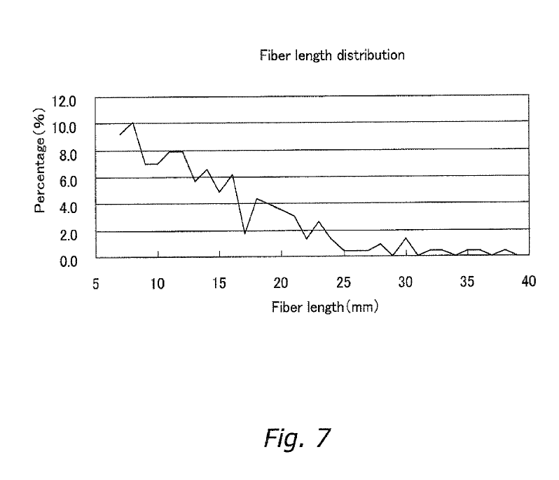

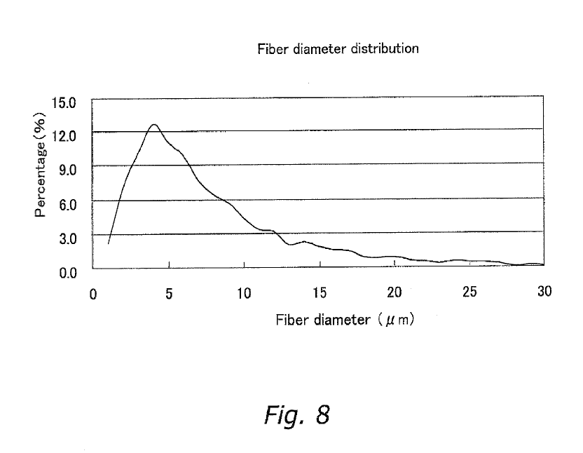

The diameters and the lengths of the fibers obtained in this way are shown in FIGS. 7 and 8.

### Fire Retardant Composite Structure Production

### EXAMPLE 1

A gel coat (polyester ISO/NPG type low-styrene gel coat obtained from Cook Composites and Polymers of Kansas City, Mo.) surface layer was applied to a mold release coated aluminum mold, and then the excess gel coat resin was removed to ensure a uniform 0.01 2 to 0.01 5 inch thick gel coat on the mold which was then allowed to harden. Then, the PTFE porous layer created with the PTFE non-woven fabric production method, described in the example above, was mechanically bonded with a fiberglass veil (a restraining layer) having a unit weight of 40 g/cm² (manufactured by Hollinee, LLC, product name: SF-100) by needle punching using 40 penetrations per square centimeter and then calendaring. This combination was placed onto the hardened gel coat such that the PTFE web rich surface was directly in contact with the gel coat and the fiberglass rich surface was facing out from the mold. The PTFE and fiberglass combination was impregnated with a polyester skin coat matrix resin (manufactured by AOC Corp., product name: Firepel K-320) using a hand lay-up method. After the polyester resin had hardened, an intumescent layer having a thickness of 1 mm and composed of Technofire® (manufactured by Technical Fibre Products Ltd.) was placed thereon. On top of this was placed a structural layer composed of two sheets of fiberglass (type 1208 fiberglass double bias (12 oz) stitched at 45 degrees along with one layer of ¾ oz chopped strand mat available from US Composites), a balsa core (ContourKore® CK100 12 mm thick supplied by Baltek of N.J.), and a single sheet of fiberglass (Type 1808 fiberglass double bias (18 oz) stitched at 90 degrees along with one layer of ¾ oz chopped strand mat available from US Composites). After all the dry layers described above had been vacuum sealed into the mold, and all leaks had been plugged up, an infusion vinyl ester matrix resin (Dow Derakane® series #411) was impregnated therein by means of a vacuum infusion molding method. After hardening, a fire retardant composite structure was formed by the combination of the aforementioned layers and resins, and was then removed from the mold. The surface flammability of the fire retardant composite structure obtained in this example, in which the gel coat was used as the surface layer, was tested using the method described in ASTM E162. The results of this test are shown in Table 1.

### Fire Retardant Composite Structure Production

### EXAMPLE 2

A fire retardant composite structure was obtained in the same manner as described in fire retardant composite structure production example 1, except that a glass veil having a unit weight of 77 g/cm² (Available from Hollinee, LLC of Shawnee, Ohio) was used as the restraining layer. The surface flammability of the fire retardant composite structure obtained in this example, in which the gel coat was used as the surface layer, was tested based upon ASTM E162. The results of this test are shown in Table 1.

### Fire Retardant Composite Structure Production

### EXAMPLE 3

A fire retardant composite structure was obtained in the same manner as described in Example 1, except that a glass veil having a unit weight of 104 g/cm² (Available from Hollinee, LLC of Shawnee, Ohio) was used as the restraining layer. The surface flammability of the fire retardant composite structure of this example, in which the gel coat was used as the surface layer, was tested based upon ASTM E162. The results of this test are shown in Table 1.

Fire Retardant Composite Structure Production

### EXAMPLE 4

A fire retardant composite structure was obtained in the same manner as described in fire retardant composite structure example 1, except that a general purpose skin coat resin (Reichhold DCPD Iso Blend Polyester type #33234-01) was used to impregnate the porous fluoropolymer layer and the restraining layer. The surface flammability and the smoke emission of this fire retardant composite structure, in which the gel coat was used as the surface layer, were respectively measured based upon ASTM E162 and ASTM E662. The results of these tests are shown in Tables 1 and 2.

Fire Retardant Composite Structure Production

### EXAMPLE 5

A fire retardant composite structure was obtained in the same manner as described in fire retardant composite structure example 4, except that a glass veil having a unit weight of 77 g/cm² (available from Hollinee, LLC of Shawnee, Ohio) was used as the restraining layer. The surface flammability and the smoke emission of this fire retardant composite structure, in which the gel coat was used as the surface layer, were respectively measured based upon ASTM E162 and ASTM E662. The results of these tests are shown in Tables 1 and 2.

### Fire Retardant Composite Structure Production

### EXAMPLE 6

A fire retardant composite structure was obtained in the same manner as described in fire retardant composite structure production example 4, except that a glass veil having a unit weight of 104 g/cm² (Available from Hollinee, LLC of Shawnee, Ohio) was used as the restraining layer. The surface flammability and the smoke emission of this fire retardant composite structure, in which the gel coat was used as the surface layer, were respectively measured based upon ASTM E162 and ASTM E662. The results of these tests are shown in Tables 1 and 2.

### COMPARATIVE EXAMPLE

A fire retardant composite structure was obtained in the same manner as described in fire retardant composite structure example 1, except that a chopped strand fiberglass mat (¾ oz per sq foot available from Fibre Glast Developments Corporation of Brookville, Ohio) was used in place of the laminated combination of the porous fluoropolymer layer and the restraining layer. The surface flammability of the fire retardant composite structure in this example, in which the gel coat was used as the surface layer, was measured based upon ASTM E162. The results of this test are shown in Table 1.

TABLE 1

| | Fs | Q | Is |
|---|---|---|---|
| Example 1 | 2.67 | 8.40 | 22.39 |
| Example 2 | 2.66 | 8.70 | 23.17 |
| Example 3 | 2.75 | 8.25 | 22.67 |
| Example 4 | 3.29 | 8.59 | 28.24 |
| Example 5 | 3.29 | 9.98 | 32.88 |
| Example 6 | 2.55 | 9.51 | 24.27 |
| Comparative | 6.41 | 10.06 | 64.53 |
| Example | | | |

TABLE 2

| | Dm (1.5) | Dm (4.0) |
|---|---|---|
| Example 4 | 8.84 | 65.71 |
| Example 5 | 24.52 | 164.54 |
| Example 6 | 24.32 | 274.16 |

A fire-retardant composite structure according to the present invention is made with a porous fluoropolymer close to the surface, and is therefore superior in terms of reducing the spread of fires that start from an external source. Also, the porous fluoropolymer non woven fabric used to make these composites has adequate thickness and strength for mechanical performance, and good drapeability necessary to make parts having three dimensional shapes. Furthermore, the porous fluoropolymer fire retardant layer does not rely upon expansion, or intumescing to slow the spread of a fire. Therefore, the porous fluoropolymer layer can be more firmly held in place by the composite structure during exposure to fire.

Any terms of degree such as “substantially,” “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A fire-retardant composite structure comprising:
a fire retardant layer having a porous fluoropolymer layer; and
a matrix resin.

2. The fire-retardant composite structure according to claim 1, further comprising:
a structural layer;
wherein said matrix resin is impregnated at least partially into said porous fluoropolymer layer and said structural layer such that said porous fluoropolymer layer and said structural layer are attached to one another.

3. The fire-retardant composite structure according to claim 1, wherein said porous fluoropolymer layer is comprised of at least one selected from the group consisting of expanded PTFE, woven fabric, non-woven fabric, felt, fiber, and powder.

4. The fire-retardant composite structure according to claim 1, wherein said porous fluoropolymer layer is comprised of non-melt-processable resin.

5. The fire-retardant composite structure according to claim 1, wherein said porous fluoropolymer layer is comprised of PTFE.

6. The fire-retardant composite structure according to claim 1, wherein said porous fluoropolymer layer is comprised of PTFE fibers.

7. The fire-retardant composite structure according to claim 1, wherein said porous fluoropolymer layer is a non-woven fabric comprised of PTFE fibers.

8. The fire-retardant composite structure according to claim 1, wherein said porous fluoropolymer layer is a blended combination comprised of PTFE fibers and one or more other materials.

9. The fire-retardant composite structure according to claim 1, wherein said porous fluoropolymer layer is comprised of modified PTFE.

10. The fire-retardant composite structure according to claim 9, wherein said modified PTFE is created by copolymerizing PTFE with at least one selected from the group consisting of hexafluoro propane, chloro trifluoro ethylene, perfluoro(alkyl vinyl ether), perfluoro(alkoxy vinyl ether), trifluoro ethylene, perfluoro alkyl ethylene, vinylidene fluoride, and ethylene.

11. The fire-retardant composite structure according to claim 1, wherein said porous fluoropolymer layer has a porosity between approximately 10% and approximately 90%.

12. The fire-retardant composite structure according to claim 1, wherein the porosity of said porous fluoropolymer layer is between approximately 25% and approximately 85%.

13. The fire-retardant composite structure according to claim 1, wherein said porous fluoropolymer layer has a mean CP porous diameter of at least 0.5 μm.

14. The fire-retardant composite structure according to claim 1, wherein said porous fluoropolymer layer has a mean CP porous diameter of at least 4.5 μm.

15. The fire-retardant composite structure according to claim 1, wherein said porous fluoropolymer layer includes pores or gaps that are sized to allow the matrix resin to flow therein.

16. The fire-retardant composite structure according to claim 1, wherein said porous fluoropolymer layer is attached to one or more other layers prior to composite fabrication.

17. The fire-retardant composite structure according to claim 1, wherein said matrix resin is at least one selected from the group consisting of vinyl ester resin, vinyl ester bromide resin, epoxy resin, unsaturated polyester resin, epoxy acrylate resin, polyimide resin, phenolic, and bismaleimide resin.

18. The fire-retardant composite structure according to claim 2, wherein said structural layer comprises at least one selected from the group consisting of glass fiber, carbon fiber, alumina fiber, silicon carbide fiber, boron fiber, p-Aramid fiber, polybenzimidazol fiber, polyetheretherketone, graphite, and poly-p-phenylbenz-bisthiazol fiber.

19. The fire-retardant composite structure according to claim 2, wherein said structural layer includes first and second reinforcement layers and a core layer, said core layer being provided between said first and second reinforcement layers, such that one or both of said porous fluoropolymer layer or layers are provided against or close to an outside surface of the composite structure in order to provide fire protection.

20. The fire-retardant composite structure according to claim 2, wherein said fire retardant layer further includes an intumescent layer.

21. The fire-retardant composite structure according to claim 20, wherein said intumescent layer is located between said porous fluoropolymer layer and said structural layer.

22. The fire-retardant composite structure according to claim 20, wherein said fire retardant layer further includes a restraining layer.

23. The fire-retardant composite structure according to claim 22, wherein said restraining layer is interposed between said intumescent layer and said porous fluoropolymer layer in order to strengthen the fire retardant layer and hold both layers in place during exposure to heat and fire.

24. The fire-retardant composite structure according to claim 22, wherein said porous fluoropolymer layer is combined with said restraining layer prior to composite fabrication.

25. The fire-retardant composite structure according to claim 22, wherein said porous fluoropolymer layer is combined with said restraining layer by entanglement prior to composite fabrication.

26. The fire-retardant composite structure according to claim 25, wherein said entanglement is performed by mechanical means such as needle punching, or hydro-entangling.

27. The fire-retardant composite structure according to claim 22, wherein said restraining layer is comprised of glass fibers or a blend of glass fibers with fluoropolymer fibers.

28. The fire-retardant composite structure according to claim 2, wherein at least one of said porous fluoropolymer layer and said structural layer has one of hydroxide, salt, and oxide of an alkali-earth metal mixed therein.

29. The fire-retardant composite structure according to claim 1, further comprising a surface coating layer applied over said fire retardant layer.

30. A fire-retardant material comprising:
a porous fluoropolymer layer; and
a glass veil.

31. The fire-retardant material according to claim 30, wherein said porous fluoropolymer layer and said glass veil are combined together by entanglement.

32. The fire-retardant material according to claim 31, wherein said entanglement is performed by needle punching.

33. The fire-retardant material according to claim 32, wherein said porous fluoropolymer layer and said glass veil are compressed after said needle punching.

34. A vehicle comprised of a fire-retardant composite structure, the fire retardant composite structure comprising:
a fire retardant layer having a porous fluoropolymer layer;
a structural layer; and
a matrix resin impregnated at least partially into said porous fluoropolymer layer and said structural layer such that said porous fluoropolymer layer and said structural layer are attached to one another.
